(19) United States
(12) Patent Application Publication
(10) Pub. No.: US 2012/0284741 A1
(43) Pub. Date: Nov. 8, 2012

(54) METHOD AND APPARATUS FOR PROVIDING VOICE CALL SERVICES VIA A SET-TOP BOX

(75) Inventors: Rajesh Shetty, Flower Mound, TX (US); Aston Tun, Flower Mound, TX (US); Sudhakar Sirigireddy, Irving, TX (US); Xuefeng Yao, Waban, MA (US); Rajesh Thevar, Carrollton, TX (US)

(73) Assignee: VERIZON PATENT AND LICENSING INC., Basking Ridge, NJ (US)

(21) Appl. No.: 13/101,814

(22) Filed: May 5, 2011

(51) Int. Cl. H04N 7/16; H04N 7/173

(52) U.S. Cl. 725/25; 725/106

(57) ABSTRACT

An approach is provided for providing telephony services via a set-top box. A provider telephony services system executes an authentication procedure to authenticate a set-top box associated with a user account. Subsequently, the set-top box receives a data stream representing a voicemail associated with the user account, wherein the data stream is selectively transcoded in real-time for delivery to the set-top box.

### BACKGROUND INFORMATION

With the convergence of telecommunications and media services, there is increased competition among service providers to offer more services and features to consumers, and concomitantly develop new revenue sources. For instance, traditional telecommunication companies are entering the arena of media services that have been within the exclusive domain of cable (or satellite) television service providers. Television remains the prevalent global medium for entertainment and information. Unfortunately, little or no attention has been paid to the integration of telecommunications services with television. Consequently, user experience with respect to television viewing and engaging in telecommunications services (e.g., calling capabilities) are independent, and thus, uncoordinated and lacking integration. For instance, a user may receive a call during a television program, which requires the user to control two different devices to attend to the call. The user may need to pause the programming or at the very least reduce the volume to receive the call. Such coordination can be cumbersome, as the user may need to retrieve the phone station and the remote control of the set-top box.

Therefore, there is a need for an approach to provide coordination between media experiences over a set-top box and other telecommunications services.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1A is a diagram of a system configured to provide telephony services to a user of video and audio equipment that interfaces with a set-top box, according to an exemplary embodiment;

FIGS. 1B and 1C are flowcharts of processes for providing voice mail and telephony processing services via a set-top box, according to various embodiments;

FIG. 2 is a diagram of a system that is configured to provide telephony services to a set-top box, according to various exemplary embodiments;

FIG. 3 is a diagram of a voicemail services platform that is configured to provide voicemail processing services to a set-top box, according to various exemplary embodiments;

FIG. 4 is a diagram of a set-top box and an associated audio/visual and user interface that are configured to interact with end users and the provider telephony services system, according to various exemplary embodiments;

FIGS. 5A and 5B are flowcharts of processes for providing voice mail and telephony processing services to an end user through a set-top box, according to an exemplary embodiment;

FIG. 6 is a flowchart of a process for initiating a telephony services session with a set-top box, according to an exemplary embodiment;

FIG. 7 is a flowchart of a process for providing call log, voicemail log and telephony services settings information to an end user through a set-top box, according to an exemplary embodiment;

FIG. 8 is a flowchart of a process for initiating a callback through a set-top box, according to an exemplary embodiment;

FIG. 9 is a flowchart of a process for providing new voicemails to an end user through a set-top box, according to an exemplary embodiment;

FIG. 10 is a flowchart of a process for receiving and storing a voicemail, according to an exemplary embodiment;

FIG. 11 is a flowchart of a process for providing old voicemails to an end user through a set-top box, according to an exemplary embodiment;

FIG. 12 shows a main menu of a graphical user interface (GUI) for receiving user selections of call services, according to an exemplary embodiment;

FIG. 13 shows a GUI sub-menu for a calling feature that provides simultaneous notification of an incoming telephony at the set-top box and another device associated with a user of the user account, according to an exemplary embodiment;

FIG. 14 shows a GUI sub-menu for receiving user selections of video related call services, according to an exemplary embodiment;

FIG. 15 shows a GUI sub-menu for receiving user selections of various telephony services features, according to an exemplary embodiment;

FIG. 16 shows a GUI display of voicemail logs and/or call logs with user selectable entries, according to an exemplary embodiment;

FIG. 17 is a diagram of a computer system that can be used to implement various exemplary embodiments; and

FIG. 18 is a diagram of a chip set that can be used to implement various exemplary embodiments.

### DESCRIPTION OF THE PREFERRED EMBODIMENT

A preferred apparatus, method, and system for providing telecommunications services via a set-top box are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a set-top box (STB), it is contemplated that these embodiments have applicability to any device capable of processing audio-video (AV) signals for presentation to a user, such as a home communication terminal (HCT), a digital home communication terminal (DHCT), a stand-alone personal video recorder (PVR), a television set, a digital video disc (DVD) player, a video-enabled phone, an AV-enabled personal digital assistant (PDA), and/or a personal computer (PC), as well as other like technologies and customer premises equipment (CPE).

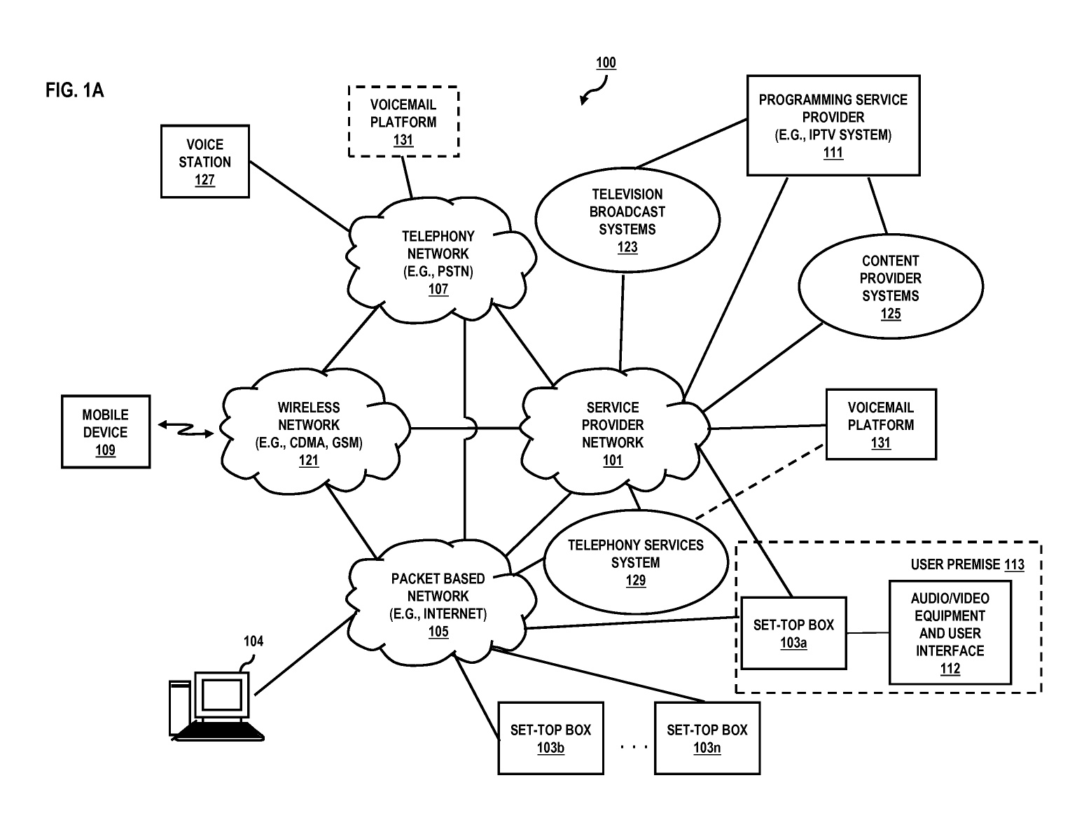

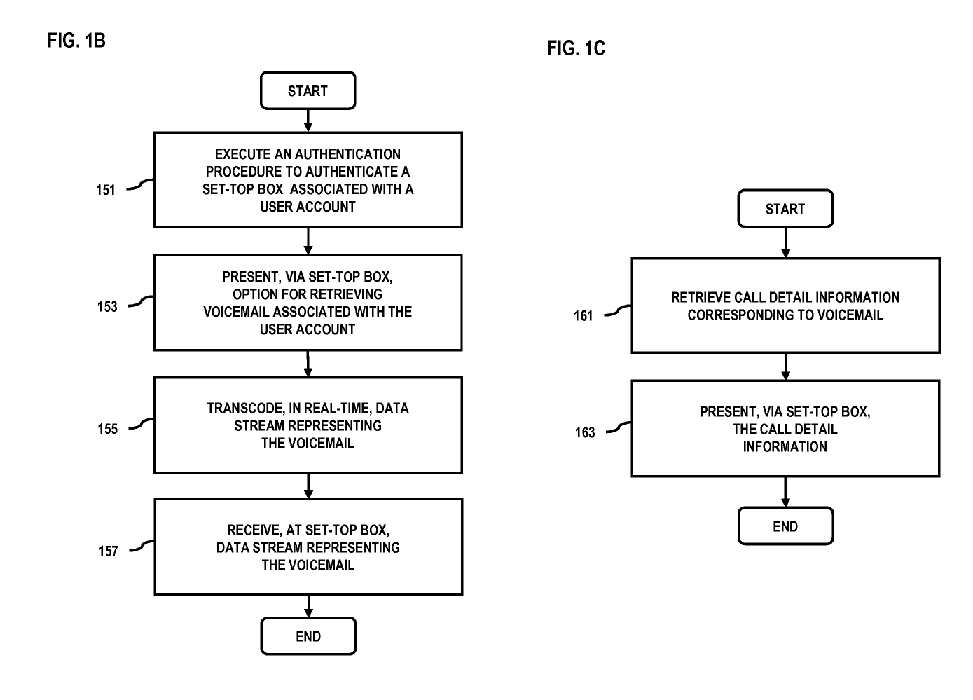

FIG. 1A is a diagram of a system configured to provide telephony processing services to a user of video and audio equipment that interfaces with a set-top box, according to an exemplary embodiment. It is observed that even with the advent of the Internet and high-speed data connections, television remains the prevalent global medium for entertainment and information. In fact, as traditional television programming (e.g., “over-the-air” programming, cable programming, satellite programming, etc.) merges with the online content (e.g., network-streamed content, on-demand content, Internet programming, media-sharing websites, etc.), the available programming choices are likely to continue to grow without any true bounds. It is also recognized that telecommunications services, such as phone calls and voice mail, are a vital part of modern society. However, no such media convergence is available for telecommunications services.

To address this problem, the system 100 of FIG. 1A enables the seamless integration of telecommunications services with media provided over an STB. In one embodiment, a user can review voicemail and call history logs on a television screen, select particular voicemails for playback, and read and/or listen to voicemails on a television coupled to the STB. Further, the user can configure and invoke various telephony services by interacting with the STB. Traditionally, no infrastructure has existed to permit telephony-based services, such a voicemail, to interface with video delivery systems. The approach of system 100 stems from the recognition that users are accustomed to consuming, simultaneously, a variety of media experiences. Moreover, users have adopted an expectation of continually being “productive.” One area that is considered a key task (or chord) for the user is the retrieval of voicemails to remain in communication with business colleagues as well as friends and family, alike.

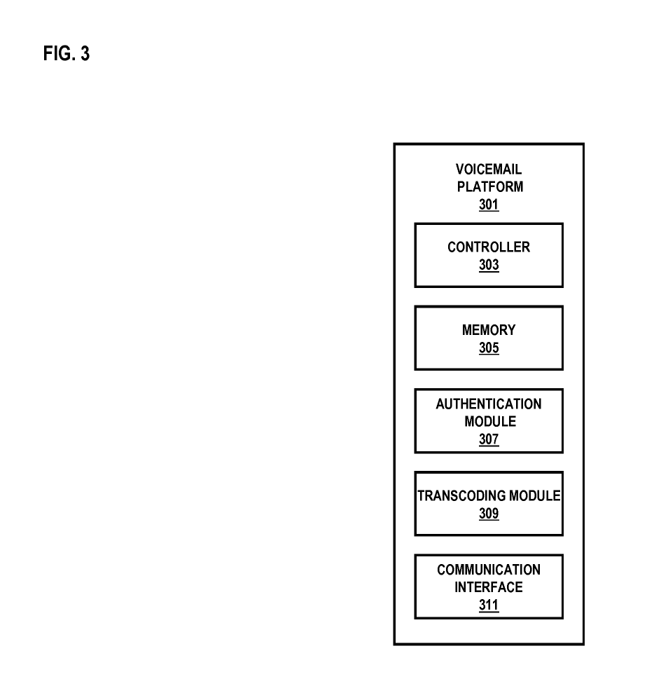

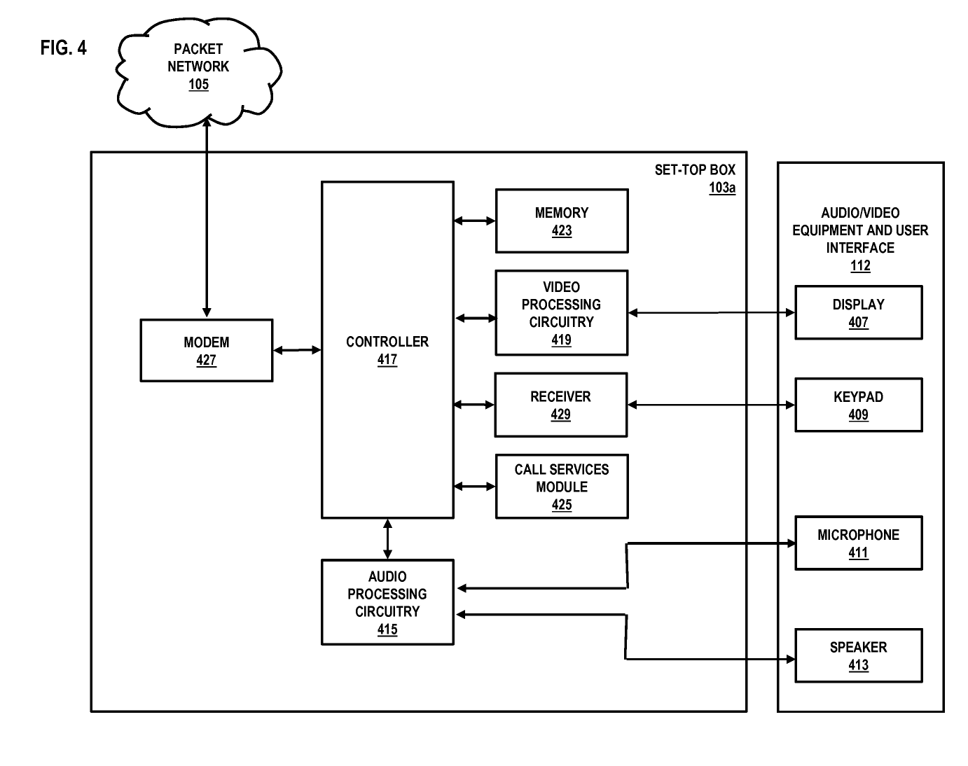

In the example of FIG. 1A, the integration of television with telecommunications is implemented by STBs 103a-103n, packet based network 105, service provider network 101, telephony network 107 and wireless network 121, and telephony services system 129. The telephony services system 129 exchanges data and commands with telephony devices, e.g. voice station 127 or mobile device 109, through the networks 101, 105, 107 and 121. In turn, the telephony services system exchanges data and commands with the STBs 103a-103n. In this manner, the STBs 103a-103n can receive data and commands from, and can send data and commands to, the mobile device 109 and voice station 127. For example, voice call information and voicemails associated with voice station 127 or mobile device 109 are provided to the telephony services system 129. Subsequently, user interaction with one of the STBs 103a-103n, such as STB 103a, can cause the telephony services system 129 to provide the telephony information and voicemails to the STB 103a. The user is provided with the convenience of addressing voicemails during commercials (or advertisements) or between programs. Audio/video equipment and user interface 112 user interface 112, which may, for example, comprise a television display, speakers and a user input device such as a remote control with a keyboard, may then display and/or play the voice call information or voicemails. The audio/video equipment and user interface 112 will be described in more detail with respect to FIG. 4. User interaction with the audio/video equipment and user interface 112 can invoke various other telephony services, and can remotely configure voice station 127 and mobile device 109 through the telephony services system 129. In one embodiment, system 129 includes a voicemail platform (or system) 131 configured to process and store voicemails received over telephony network 107, wireless network 121, and/or service provider network 101. As shown, voicemail platform 131 can be implemented as part of the service provider network 101, telephony services system 129, or telephony network 107. Further, it is contemplated that the voicemail platform 107 can deployed as a service that is part of the packet based network 105. In some embodiments, voicemail platform 131 includes the components shown in FIG. 3 to receive and process voicemails from the various networks 107, 121, and 101.

In the example of FIG. 1A, service provider network 101 integrates the television medium with that of the telecommunications, computing, and media environments, thereby broadening the scope of devices and sources available to individuals for obtaining telephony services and programming content or other media. By way of example, service provider network 101 provides programming content that may include any audio-visual content (e.g., broadcast television programs, digital video recorder (DVR) content, on-demand programs, pay-per-view programs, IPTV (Internet Protocol Television) feeds, DVD related content, etc.), pre-recorded media content, data communication services content (e.g., commercials, advertisements, videos, movies, songs, audio books, etc.), Internet-based content (e.g., streamed video, streamed audio), and/or any other equivalent media form.

STBs 103a-103n and/or terminal 104 can communicate using the packet-based network 105 and/or the telephony network 107. These systems can include: a public data network (e.g., the Internet), various intranets, local area networks (LAN), wide area networks (WAN), the public switched telephony network (PSTN), integrated services digital networks (ISDN), other private packet switched networks or telephony networks, as well as any additional equivalent system or combination thereof. These networks may employ various access technologies including cable networks, satellite networks, subscriber television networks, digital subscriber line (DSL) networks, optical fiber networks, hybrid fiber-coax networks, worldwide interoperability for microwave access (WiMAX) networks, wireless fidelity (Wi-Fi) networks, other wireless networks (e.g., 3G wireless broadband networks, mobile television networks, radio networks, etc.), terrestrial broadcasting networks, provider specific networks (e.g., a Verizon® FiOS® network, a TiVo network, etc.), and the like. Such networks may also utilize any suitable protocol supportive of data communications, e.g., transmission control protocol (TCP), internet protocol (IP), file transfer protocol (FTP), telnet, hypertext transfer protocol (HTTP), asynchronous transfer mode (ATM), socket connections, Ethernet, frame relay, and the like, to connect STBs 103a-103n to various sources of media content. Although depicted in FIG. 1A as separate networks, packet-based network 105 and/or telephony network 107 may be completely or partially contained within service provider network 101. For example, service provider network 101 may include facilities to provide for transport of packet-based and/or telephony communications.

Mobile device 109 may communicate with wireless network 121, which may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., WiMAX), WiFi, satellite, and the like.

As discussed previously, media or programming content broadly includes any audio-visual content (e.g., broadcast television programs, VOD programs, pay-per-view programs, IPTV feeds, DVD related content, etc.), pre-recorded media content, data communication services content (e.g., commercials, advertisements, videos, movies, songs, images, sounds, etc.), Internet services content (streamed audio, video, or pictographic media), and/or any other equivalent media form. In this manner, a programming service provider 111 may provide (in addition to the provider's own programming content) content obtained from other sources, such as one or more television broadcast systems 123, one or more third-party content provider systems 125, content residing in a repository (not shown) or accessible via server (not shown), as well as available via one or more packet-based networks 105 or telephony networks 107, etc.

STBs 103a-103n may be used alone or in combination with one or more end terminal(s) 104 to implement various exemplary embodiments. Under the scenario of FIG. 1A, user premise 113 includes terminal 104. Also, it is contemplated that user premise 113 can house multiple STBs.

In the example of FIG. 1A, STBs 103a-103n are located at one or more user premises (e.g., user premise 113), and geospatially associated with one or more regions. STBs 103a-103n may be configured to communicate with and receive signals and/or data streams from a programming service provider 111 (or other transmission facility). These signals include results of applying search or browse operations on the available programming content (e.g., video assets) and related data (e.g., programming guide data, metadata) retrieved over a data network (e.g., service provider network 101, packet-based network 105, and/or telephony network 107), as well as conventional video broadcast content.

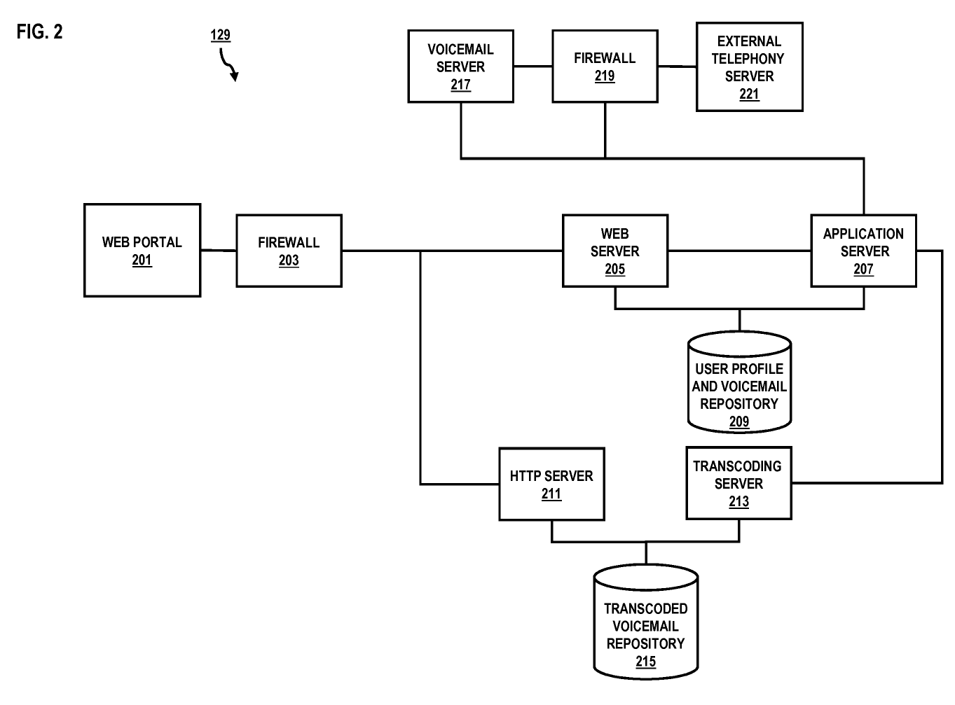

In one embodiment, a user profile and voicemail repository 209, shown in FIG. 2 as part of the telephony services system 129, may be employed to maintain subscribers to the set-top boxed based telephony services system. The repository 209 may be accessed via one or more service provider networks 101 and/or packet-based networks 105. In one embodiment, the user profile and voicemail repository 209 stores user settings, STB addresses (identifiers), user preferences, and configuration information for the service. Further, service provider network 101 may include a system administrator (not shown) for operational and management functions to deploy the virtual channel service using, for instance, an internet protocol television (IPTV) system. In this manner, STBs 103a-103n can utilize any suitable technology to draw, receive, and/or transmit media content from/to a programming service provider 111 or other content source/sink. A more detailed explanation of an exemplary STB is provided with respect to FIG. 4.

In one embodiment, STBs 103a-103n can draw, receive, and/or transmit programming guide information and related content from (or to) multiple sources, thereby alleviating the burden on any single source, e.g., programming service provider 111, to gather, supply, or otherwise meet the content demands of any user or premise. Thus, particular embodiments enable authenticated third-party television broadcast systems 123, third-party content provider systems 125, and servers (not shown) to transmit programming content accessible over a data network to STBs 103a-103n either apart from, or in conjunction with, programming service provider 111. Such programming content may include content regarding traffic, news, sports, current events, breaking stories, commentary, headlines, advertisements, solicitations, financial advice, stocks, markets, events, schools, governments, blog entries, podcasts, and the like. Moreover, media content may be available from authenticated sources, including grassroots groups or individuals, non-profits, governmental organizations, public/private institutions, etc.

In various embodiments, service provider network 101 may include one or more video and/or audio processing modules (not shown) for acquiring and transmitting programming guide information and related content feeds (including content accessible over a data network) from programming service provider 111, the television broadcast systems 123, the third-party content provider systems 125, or servers (not shown) over one or more of the networks 101, 105, 107, to particular STBs 103a-103n. Accordingly, service provider network 101 may include facilities to support compression/decompression, coding/decoding, modulation/demodulation, optical/electrical conversion, and analog/digital conversion, as well as any other suitable signal processing and/or transmission operation. Further, service provider network 101 can optionally support end-to-end data encryption in conjunction with the exchange of information between one of the STBs 103a-103n and the telephony services system 129, programming guide creation and related content streaming services such that only authorized users are able to access personalized telephony services or programming guides.

Moreover, system 100 may include an authentication module configured to perform authorization/authentication services and determine whether users or content sources are indeed subscribers to STB based telephony services. The authentication module is part of the telephony services system, and will be described with reference to FIGS. 3, 5A and 6.

The system 100 may also include a separate authorization module that can verify whether users are subscribers to other services such as the personalized programming guide service. For these purposes, an authentication schema may require a user name and password, a key access number, a unique machine identifier (e.g., media access control (MAC) address), etc., as well as a combination thereof. Once a subscriber has authenticated a presence on system 100, the user may bypass additional authentication procedures for executing later applications (e.g., programming content streaming instances). Data packets, such as cookies, may be utilized for this purpose. Thus, once an STB or content source is authenticated, connections between the STBs 103a-103n and the content sources may be established directly or through the programming service provider 111.

In other embodiments, authentication procedures on a first device (e.g., STB 103a) may identify and authenticate a second device (e.g., terminal 104) communicatively coupled to, or associated with, the first device. Further, the authentication module may grant users the right to receive programming guide information and related content from multiple sources by revoking existing sets of digital certificates associated with a particular provider, and issuing new sets of digital certificates mapped to a second provider. In this regard, an STB (e.g., STB 103a) may receive new programming content or guide information from a second source, whereas the previous session may be automatically closed when the “old” or prior certificates associated with the first source are revoked. This enables users to initiate secure sessions at any given STB 103a-103n (or end terminal 104) linked to system 100, whether or not the STB (or end terminal) belongs to that individual user. It is additionally contemplated that multiple rights sessions may exist concurrently.

In particular embodiments, programming service provider 111 may comprise an IPTV system configured to support the transmission of television video programs from the broadcast systems 123 as well as other content, such as content from the various third-party sources (e.g., 123, 125) utilizing internet protocol (IP). That is, the IPTV system 111 may deliver programming guide information, signals and/or streams, including programming content accessible over a data network, in the form of IP packets. Further, the transmission network (e.g., service provider network 101) may optionally support end-to-end data encryption in conjunction with the streaming services, as previously mentioned.

In this manner, the use of IP permits television services to be integrated with broadband Internet services, and thus, share common connections to a user site. Also, IP packets can be more readily manipulated, and therefore, provide users with greater flexibility in terms of control and offers superior methods for increasing the availability of programming guide information and related content. Delivery of video content, by way of example, may be through a multicast from the IPTV system 111 to the STBs 103a-103n. Any individual STB may tune to a particular content source by simply joining a multicast (or unicast) of the media content, utilizing an IP group membership protocol (IGMP). For instance, the IGMP v2 protocol may be employed for joining STBs to new multicast (or unicast) groups. Such a manner of content delivery avoids the need for expensive tuners to view media content, such as television broadcasts; however, other delivery methods, such as directly modulated carriers (e.g., national television systems committee (NTSC), advanced television systems committee (ATSC), quadrature amplitude modulation (QAM)), may still be utilized. It is noted that conventional delivery methods may also be implemented and combined with the advanced methods of system 100. Further, the programming content may be provided to various IP-enabled devices, such as those computing, telephony, and mobile apparatuses previously delineated.

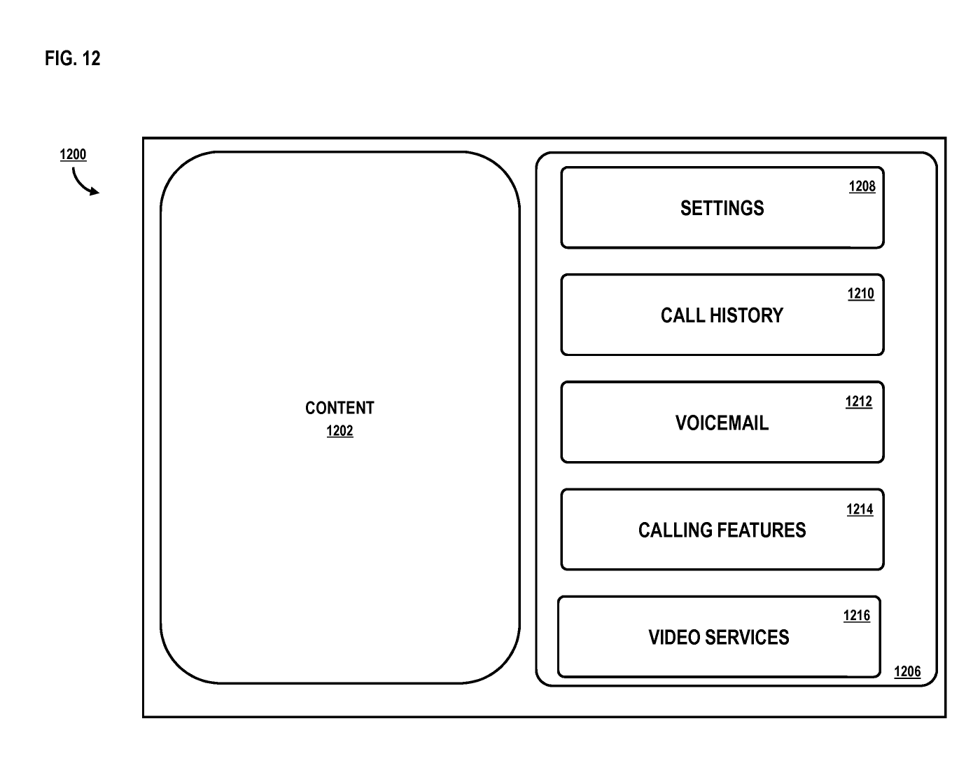

An STB (e.g., STB 103a) may integrate telephony services with all the functions of an IPTV system and analog broadcast television, as well as combine the programming content and video asset management functions of the various online or off-line environments. For example, as will be described with reference to FIGS. 12-16, a STB (e.g. STB 103a) operating in conjunction with audio/video equipment (e.g. audio/video equipment and user interface 112), may simultaneously provide to an end user both telephony services information and television and other content.

Although the user equipment is described with respect to an STB 103a, it is contemplated that various embodiments have applicability to any device capable of processing video, audio, and/or multimedia streams. More generally, while system 100 is illustrated in FIG. 1A, the exemplary components are not intended to be limiting, and indeed, additional or alternative components and/or implementations may be utilized.

FIGS. 1B and 1C are flowcharts of processes for providing voice mail and telephony processing services via a set-top box, according to various embodiments. In step 151, an authentication procedure is executed to authenticate a set-top box (e.g., set-top box 103a) associated with a user account.

In step 153, the set-top box 103a presents an option to view an item corresponding to the voicemail. According to certain embodiments, the option can be presented using the graphical user interface (GUI) shown in FIG. 12. The selection of the item invokes downloading of the data stream. It is contemplated that a video program can be concurrently presented with the option, as to provide a seamless experience for the user. The set-top box 103a can receive a data stream representing a voicemail associated with the user account, wherein the data stream is selectively transcoded in real-time for delivery to the set-top box 103a (steps 155 and 157).

As shown in FIG. 1C, in one embodiment, the set-top box 103a retrieves, per step 161, call detail information corresponding to the voicemail, and presents the call detail information. The call detail information can include information for various telephony services associated with the user account. Moreover, the set-top box 103a can display or otherwise present a calling processing menu that includes one or more call processing features relating to a call associated with the user account (step 163). By way of example, these features include simultaneous ringing, call forwarding, incoming call block, do not disturb, etc.

The above process can be performed within system 100 of FIG. 1A, more specifically, the transcoding of voicemails may be implemented within telephony services system 129.

FIG. 2 is a diagram of a provider telephony services system that is configured to provide telephony services to a set-top box, according to various exemplary embodiments. The system 129 comprises a web portal 201, web server 205, application server 207, Hypertext Transfer Protocol (HTTP) server 211, transcoding server 213, voicemail server 217 and external telephony server 221. The web portal 201 and the external telephony server 221 are connected to the packet based network 105 (FIG. 1A). The web-portal 201 is connected to the web server 205 through a firewall 203. Similarly, the external telephony server 221 is connected to the voicemail server 217 and the application server 207 through a firewall 219.

The web portal 201 communicates with the STBs 103a-103n (FIG. 1A) over the packet based network 105. The web server 205 handles user authorization and user profile and customization tasks by accessing the user profile and voicemail repository 209. The web server 205 also retrieves call logs, voicemail logs and old voicemail from the user profile and voicemail repository 209. The web server provides the old voicemails to the transcoding server 213, which transcodes the voicemails and stores the transcoded voicemails in transcoded voicemail repository 215. The transcoded voicemails are then streamed to the pertinent one of the STBs 103a-103n through the HTTP server 211 and the web portal 201. Finally, the web server 205 enables phone calls to be originated by the STBs 103a-103n by routing a target telephone number to the application server 207, which in turn provides the telephone number to the external telephony server 221. The external telephony server 221 then calls the telephone number by accessing packet network 105 (FIG. 1A), which in turn accesses telephony network 107 (FIG. 1A).

The application server 207 also receives voicemails for telephone numbers associated with the STBs 103a-103n from the external telephony server 221. The application server 207 stores these voicemails in the user profile and voicemail repository 209. The application server 207 also provides these voicemails to the transcoding server 213, which transcodes the voicemails and stores the transcoded voicemails in transcoded voicemail repository 215.

New voicemails are accessed directly in the transcoded voicemail repository by the HTTP server 211 upon receiving a voicemail request from the web portal 201. The transcoded voicemails are then streamed to the pertinent one of the STBs 103a-103n through the HTTP server 211 and the web portal 201.

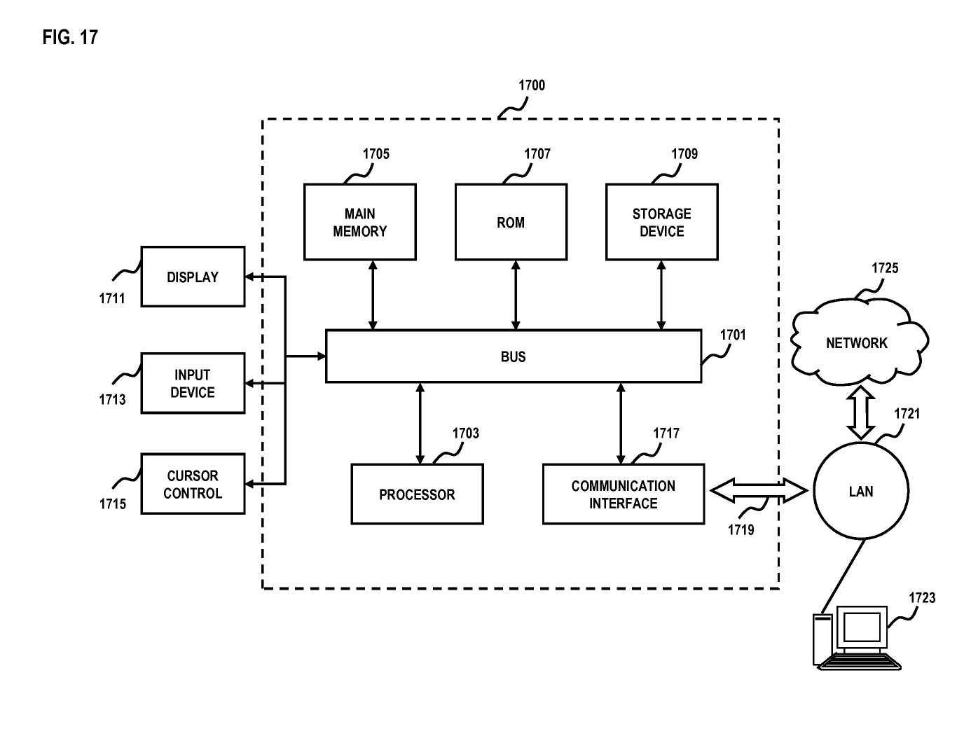

FIG. 3 is a diagram of a voicemail services platform, which is part of the provider telephony services system 129, and is configured to provide voicemail processing services to a set-top box, according to various exemplary embodiments. Voicemail platform (or platform) 301 may comprise computing hardware (such as described with respect to FIG. 17), as well as include one or more components configured to execute the processes described herein to facilitate the set-top based telephony processing services of system 100. In one implementation, platform 301 includes controller (or processor) 303, memory 305, authentication module 307, transcoding module 309, and communication interface 311. Platform 301 may also communicate with one or more facilities or repositories, such as user profile and voicemail repository 209 (FIG. 2) and transcoded voicemail repository 215 (FIG. 2). While specific reference will be made to this particular implementation, it is contemplated that platform 301 may embody many forms and include multiple and/or alternative components. For example, it is contemplated that the components of platform 301 may be combined, located in separate structures, or separate locations. For example, with reference to FIG. 2, the authentication module 307 may be located within web server 205 while the transcoding module 307 may be located within transcoding server 213.

According to exemplary embodiments, platform 301 may be configured to receive via, for example, communication interface 311, one or more requests from one of the STBs 103a-103n (FIG. 1A) over, for example, service provider network 101 to perform STB authentication and voicemail transcoding. Voicemails may originate from the external telephony server 221 (FIG. 2) and be received by platform 301 via communication interface 311. The voicemail is placed in memory 305 and the transcoding module 309 transcodes the email under control of controller 303. The transcoded voicemail is then sent, for example, to the transcoded voicemail repository 215 (FIG. 2) via communication interface 311.

In an exemplary embodiment, STB authentication is performed when an end-user initiates a telephony services session at one of the STBs 103a-103n. The unique address of the STB to be authenticated is provided to the voicemail platform 301, which looks up the address in a valid user section of the user profile and voicemail repository 209. If the address is found, the STB in question, for example STB 103a, is successfully authenticated, and the voicemail platform 301 sends an appropriate message to the STB 103a.

FIG. 4 is a diagram of a STB and an associated audio/visual and user interface that are configured to interact with end users and the provider telephony services system 129, according to various exemplary embodiments. In this example, STB 103a includes a controller 417, a memory 423, audio processing circuitry 415, video processing circuitry 419, receiver 429, call services module 425 and modem 427. While specific reference will be made hereto, it is contemplated that set-top box 103a may embody many forms and include multiple and/or alternative components.

According to exemplary embodiments, audio/video equipment and user interface 112 may include one or more displays 407, keypads 409, microphones 411, and/or speakers 413. Display 407 provides a graphical user interface (GUI) that permits a user of set-top box 103a to view dialed digits, call status, menu options, and other service information. The GUI, portions of which will be described with reference to FIGS. 12-16, may include icons and menus, as well as other text and symbols. Keypad 409 includes an alphanumeric keypad and may comprise a portion of a remote control device. The keypad 409 may represent other input controls, such as one or more button controls, dials, joysticks, touch panels, etc. As such, a user may utilize one or more components of audio/video equipment to construct user profiles, enter commands, initialize applications, input remote addresses, select options from menu systems, and the like. In this manner, it is noted that microphone 411 converts spoken utterances of a user (or other auditory sounds, e.g., environmental sounds) into electronic audio signals, whereas speaker 413 converts audio signals into audible sounds.

The controller 417, while referred to in the singular, may comprise a plurality of controllers, which may include, for example, both general purpose and special purpose controllers and digital signal processors. Controller 417 may interface with audio processing circuitry 415, which provides basic analog output signals to speaker 413 and receives analog audio inputs from microphone 411. Similarly, controller 417 may interface with video processing circuitry 419, which provides basic analog output signals to display 407. The controller 417 may interface with the receiver 429 to receive signals from keypad 409. The signals may be conveyed wirelessly through electromagnetic waves (e.g. radio-frequency, infrared) and/or through a wire (not shown) connecting the keypad 409 to the set-top box 103a.

Memory 323 may represent a hierarchy of memory, which may include both random access memory (RAM) and read-only memory (ROM). Computer program instructions and corresponding data for operation can be stored in non-volatile memory, such as erasable programmable read-only memory (EPROM), electrically erasable programmable read-only memory (EEPROM), and/or flash memory. Memory 423 may be implemented as one or more discrete devices, stacked devices, or integrated with controller 417. Memory 423 may store information, such as a unique STB that serves to identify the STB 103a, one or more user profiles, one or more user defined policies, one or more contact lists, personal information, sensitive information, work related information, configurable telephony parameters, and the like.

Set-top box 103a also includes call services module 425 that is configured to receive, transmit, and/or process voice calls, voicemails, user settings and other information pertaining to telephony services. The call services module 425, in conjunction with the controller 417, video processing circuitry 419 and audio processing circuitry 415, is also configured to cause a telephony services GUI, described in more detail with reference to FIGS. 12-16, to appear on the display 417, and to process user input provided by keypad 409 and/or microphone 411 in connection therewith.

Upon receiving a telephony services initiation request from the audio/video equipment and user interface 112, the controller 417 and call services module 425 cause the modem 427 to send the STB address and a telephony services initiation request to the web portal 201 (FIG. 2) over packet network 105. The video call services system 129 performs authentication as described with reference to FIGS. 2, 3, 5 and 6. If the STB 103a is authenticated, the modem 427 receives an authentication message over packet network 105, and, in turn, the call services module 425 and the controller 417 cause the video processing circuitry 419 to provide an appropriate call services menu to the display 407. An exemplary call service menu will be described with reference to FIG. 12. An audible authentication notice may also be provided to speakers 413 by audio processing circuitry 415.

In like manner, the modem 427, controller 417 and call services module 425 operate in conjunction to send user telephony services requests and telephony audio and/or video streams to the video call services system 129 through web portal 201, and to receive therefrom telephony services information, such as telephony logs, voicemail logs, voicemail content, and telephony audio and/or video streams. In turn, this information may be provided to the display 407 and/or speaker 413.

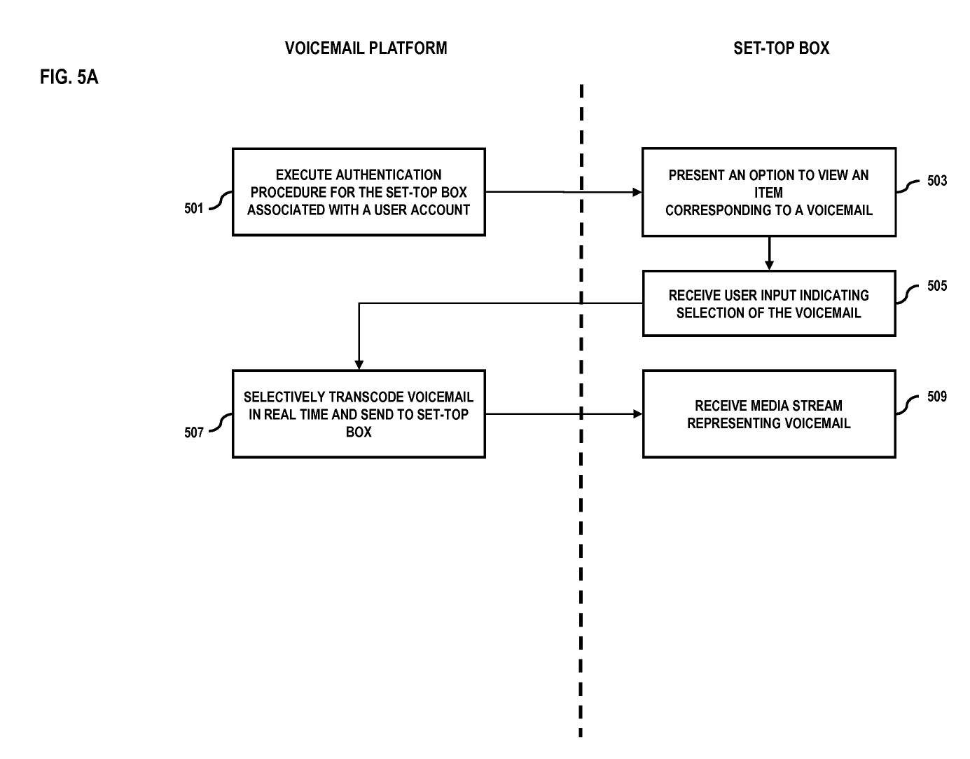

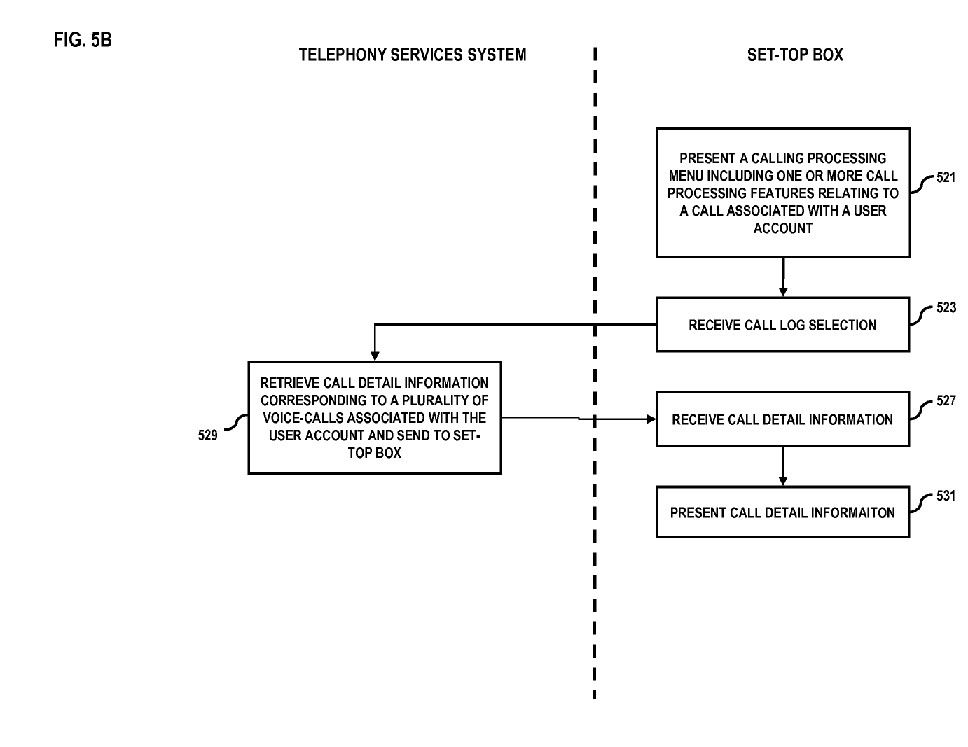

FIG. 5A is a flowchart of a process for providing voice mail processing services to an end user through a set-top box, according to an exemplary embodiment. According to an exemplary embodiment, the process shown in FIG. 5 may be performed by the voicemail platform 301 (FIG. 3) operating in conjunction with one of the STBs 103a-103n. In step 501, the voice mail platform 301 executes an authentication procedure for a set-top box, e.g. STB 103a, associated with a user account. As previously described with reference to FIG. 3, in an exemplary embodiment, authentication is performed by looking up the unique address of the STB in a valid user section of the user profile and voicemail repository 209 (FIG. 2).

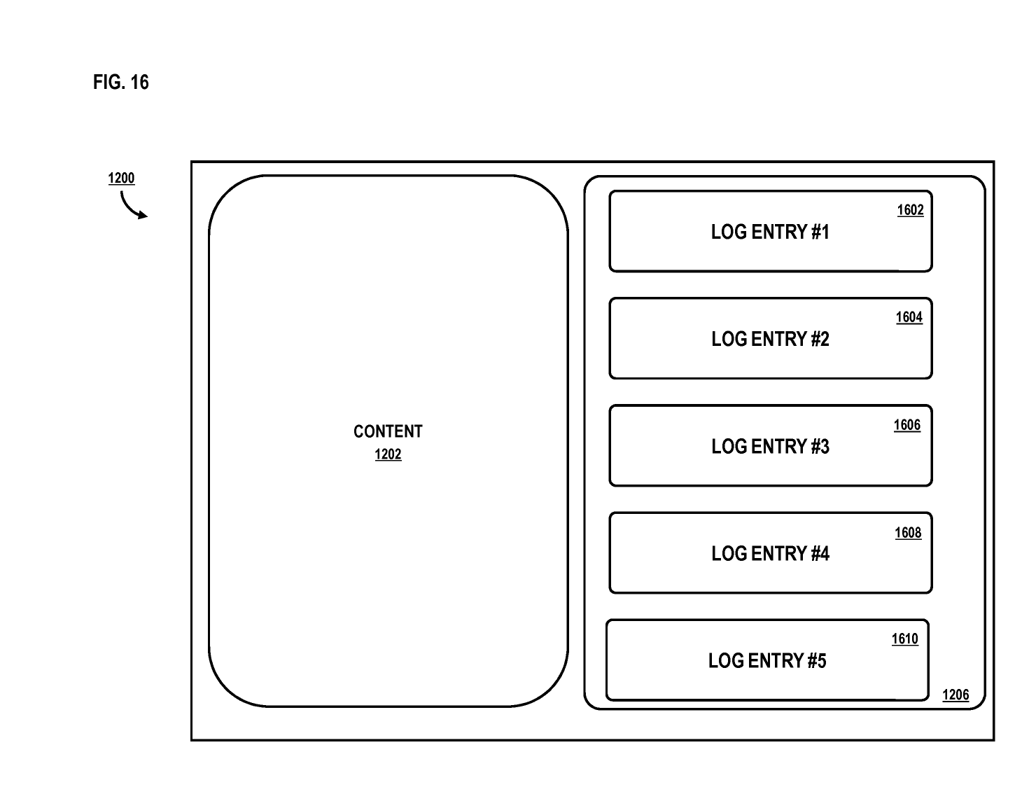

Next, step 503 is performed. Although FIG. 5 shows a connection between steps (blocks) 501 and 503, intervening steps may occur between steps 501 and 503. For example, some time after authentication in step 501 but before step 503, the STB 103a may cause the display 407 (FIG. 4) to display a menu with telephony processing options. In any event, step 503 entails presenting an option to view an item corresponding to a voicemail. An exemplary GUI for such a presentation will be described with reference to FIG. 16.

Next, according to step 505, the STB 103a receives user input, via for example keypad 409, indicating the selection of a particular voicemail that the user wishes to see/hear. In step 507, the voicemail platform 301 selectively transcodes the target voicemail and sends the transcoded voicemail, in the form of a media stream, to the STB 103a. In step 509, the STB 103a receives the media stream representing the voice mail, which may then be played/displayed on the audio/video equipment and user interface 112 (FIG. 4).

FIG. 5B is a flowchart of a process for providing telephony processing services to an end user through a set-top box, according to an exemplary embodiment. The telephony processing services involve the interaction between the telephony services system 129 (FIG. 2) and one of the STBs 103a-103n, which for purposes of illustration will be taken as STB 103a. According to step 521, the STB 103a presents on display 407 (FIG. 4) a calling processing menu including one or more call processing features relating to a call associated with a user account. In an exemplary embodiment, the calling processing menu includes a call log feature. An exemplary GUI associated with step 521 will be described with reference to FIG. 12.

If the user selects the call log feature, then an appropriate selection signal is received by the STB 103a according to step 523. Next, the call log selection is sent to the telephony services system 129, which then, in step 529, retrieves telephony detail information corresponding to a plurality of voice-calls associated with the user account, and sends this information to STB 103a. According to step 527, this information is received by the STB 103a, which then presents this information to the user according to step 531. An exemplary GUI associated with step 531 will be described with reference to FIG. 16.

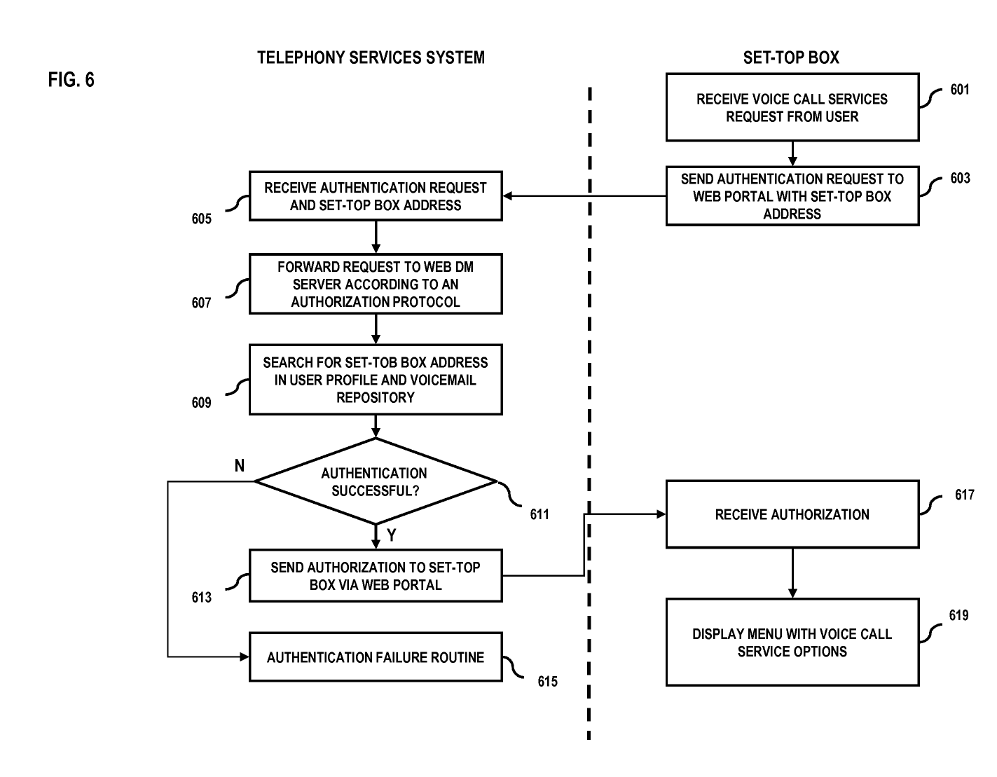

FIGS. 6-11 are flowcharts of various processes pertaining to the provision of telephony services via a set-top box. FIGS. 6-9 and 11 involve the interaction between the telephony services system 129 (FIG. 2) and one of the STBs 103a-103n, which for purposes of illustration will be taken as STB 103a. Moreover, the GUI associated with various aspects of the services shown in FIGS. 6-9 and 11 will be described in greater detail with respect to FIGS. 12-16. In exemplary embodiments, communication between the STB 103a and the telephony services system 129 occurs over the packet network 105 and the service provider network 101. For example, data sent from the STB 103a may be routed over the packet network 105 to a facility controlled by the service provider, which may perform intermediate processing/routing of the data before sending it to the web portal 201 within the telephony services system 129 over the packet network 105.

FIG. 6 is a flowchart of a process for initiating a telephony services session with a set-top box, according to an exemplary embodiment. According to step 601, the STB 103a receives a telephony services request from a user, which indicates that the user wishes to access various telephony service features through the STB 103a. Next, according to step 603, an authentication request along with the address of STB 103a is sent to the web portal 201.

In step 605, the web portal receives the authentication request and the address of STB 103a. The web portal 201 forwards, as in step 607, the request to web server 205, through firewall 203, according to an authorization protocol. In step 609, the web server 205 searches for the address of STB 103a in the valid user section of the user profile and voicemail repository 209. Next, in step 611, the web server 205 determines whether the address was located, and therefore whether the authorization is successful. If so, in step 613, an authorization message is sent to the STB 103a through the web portal 201. Otherwise, the authorization is not successful, and an authorization failure routine is invoked in step 615. According to exemplary embodiments, the authorization failure routine may involve sending the STB 103a a message indicating that the authorization failed.

Returning to step 613, if the authorization succeeded, then in step 617, the STB 103a receives notification thereof. In step 619, the STB 103a causes display 407 (FIG. 4) to display a menu with user selectable telephony service options. An exemplary GUI for displaying these menu options will be described with reference to FIG. 12. According to exemplary embodiments, after the initial authentication described above, the user may invoke telephony services, e.g., playing a voice mail, without the need for additional authentication of the type performed in step 609, until the user ends the telephony services session.

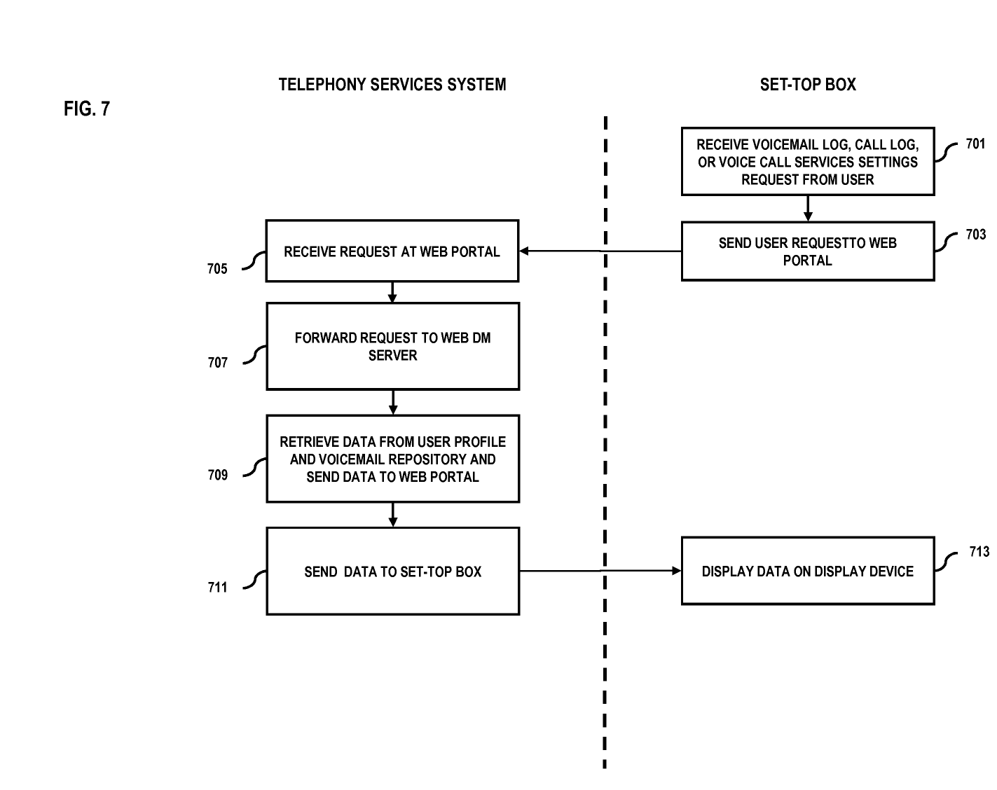

FIG. 7 is a flowchart of a process for providing call log, voicemail log and telephony services settings information to an end user through a set-top box, according to an exemplary embodiment. In step 701, the STB 103a receives a user request to display a log of voice mails, a log of voice calls, or the user's telephony service settings. In step 703, the request is sent to the web portal 201, which receives the request in step 705.

In step 707, the request is forwarded to the web server 205 through firewall 203. In step 709, the web server 205 retrieves the pertinent data from the user profile and voicemail repository 209, and sends the data to the web portal 201. In step 711, the web portal 201 forwards the data to the STB 103, which, according to step 713, presents the data on the display 407. An exemplary GUI for displaying voice call logs and voicemail logs will be described with reference to FIG. 16.

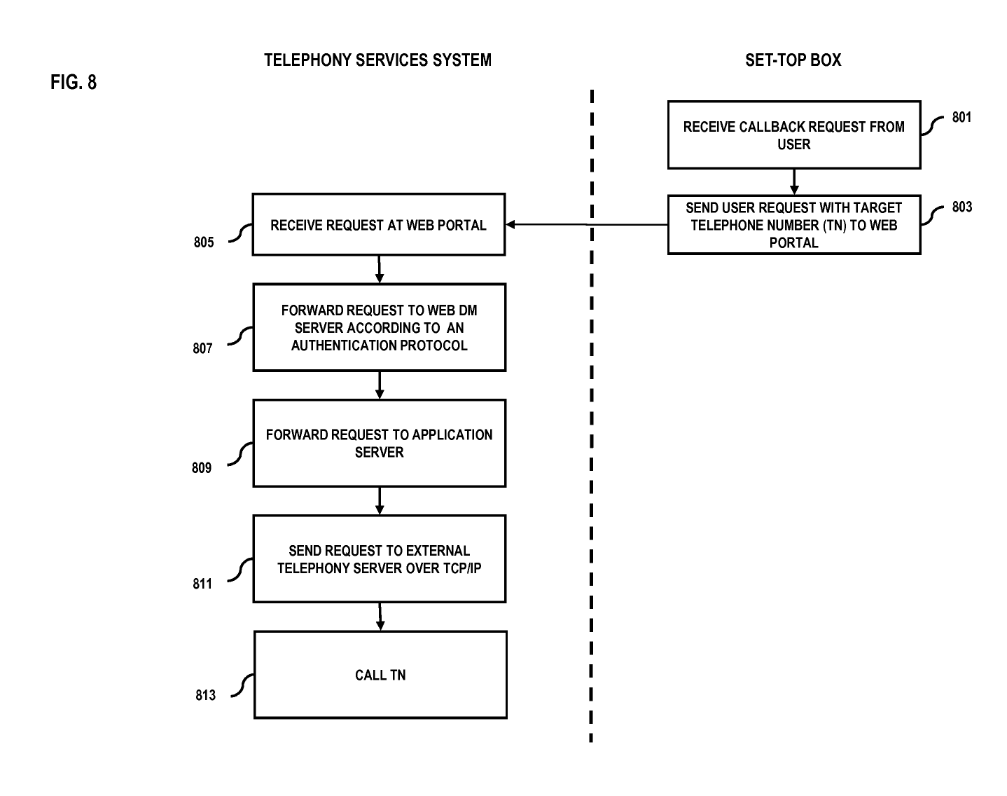

FIG. 8 is a flowchart of a process for initiating a callback through a set-top box, according to an exemplary embodiment. In step 801, the STB 103a receives a user request to call a telephone number. For example, the telephone number may have appeared in a call log, and the user may have selected the call log entry and sent STB 103a a “call” command. In step 803, the request is sent to the web portal 201, which receives the request in step 805.

In step 807, the request is forwarded to the web server 205, through firewall 203, according to an authentication protocol. In step 809, the web server 205 forwards the request to the application server 207 (FIG. 2). In step 811, the application server 207 sends the request to the external telephony server 221, through firewall 219, according to a TCP/IP protocol, for example. In step 813, the external telephony server 221 calls the telephone number.

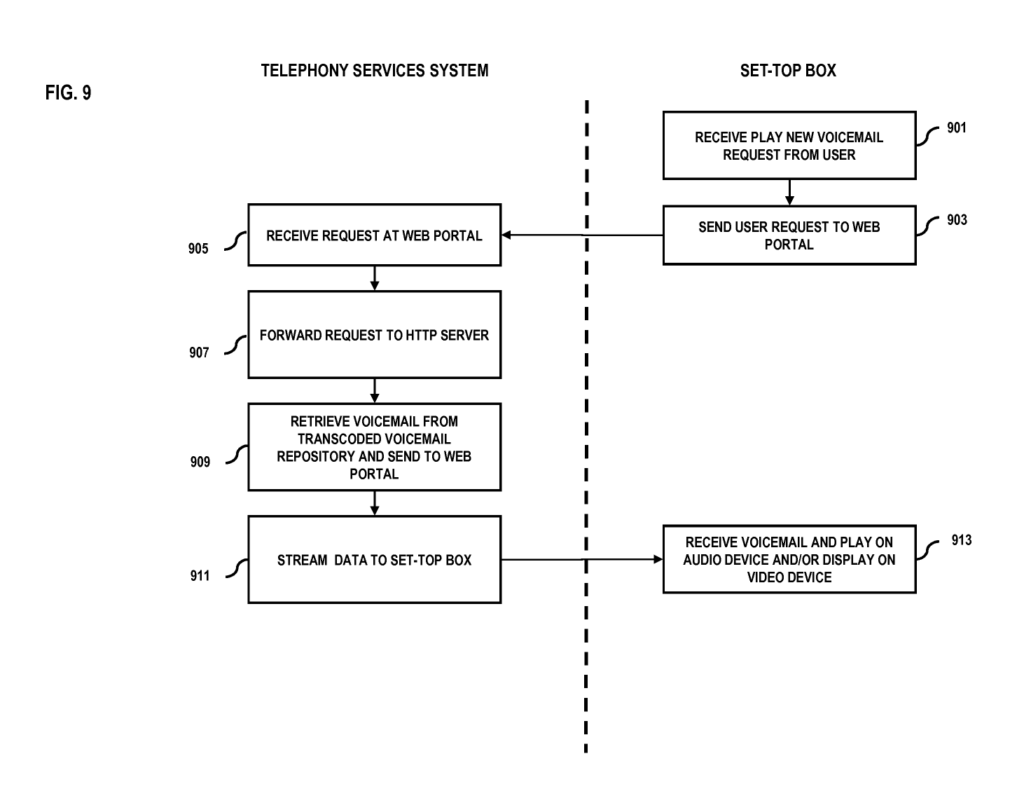

FIG. 9 is a flowchart of a process for providing new voicemails to an end user through a set-top box, according to an exemplary embodiment. In step 901, the STB 103a receives a user request to play a “new” voice mail, i.e., a voice mail that has not yet been played. In step 903, the request is sent to the web portal 201, which receives the request in step 905.

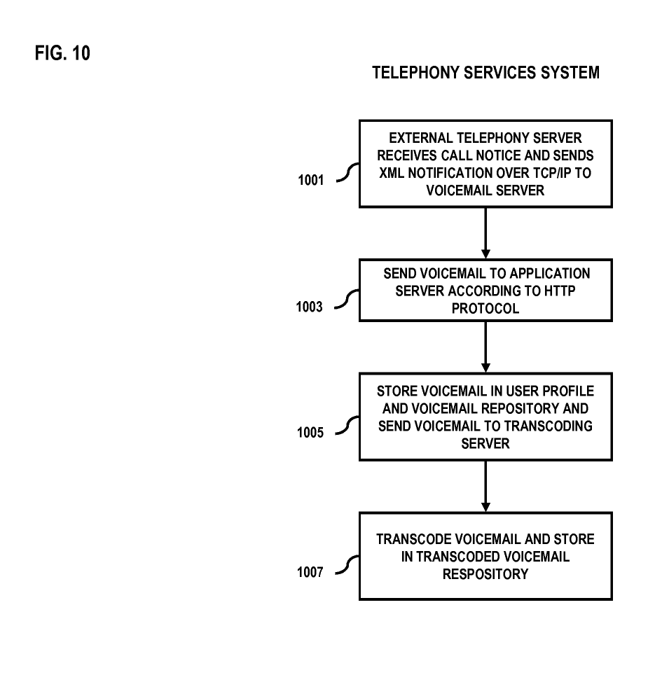

In step 907, the request is forwarded to the HTTP server 211, through firewall 203. In step 909, the HTTP server 211 retrieves a transcoded version of the voice mail from the transcoded voicemail repository 215 and sends it to the web portal 201. New voicemails are transcoded and stored in the transcoded voicemail repository 215 according to the process described with respect to FIG. 10. Returning to FIG. 9, in step 911, the web portal 201 streams the voicemail to the STB 103a. In step 913, which may occur iteratively with step 911 since the voicemail is streamed, the STB 103a receives the voicemail and plays it on speaker 413 (FIG. 4) and/or displays it on display 407 (FIG. 4).

FIG. 10 is a flowchart of a process for receiving and storing a voicemail, according to an exemplary embodiment. In step 1001, the external telephony server 221 (FIG. 2) receives a voice mail that is directed to a telephone number associated with the STB 103a. The external telephony server 221 sends an eXtensible Mark-up Language (XML) notification of the voicemail over TCP/IP to the voicemail server 217 through the firewall 219.

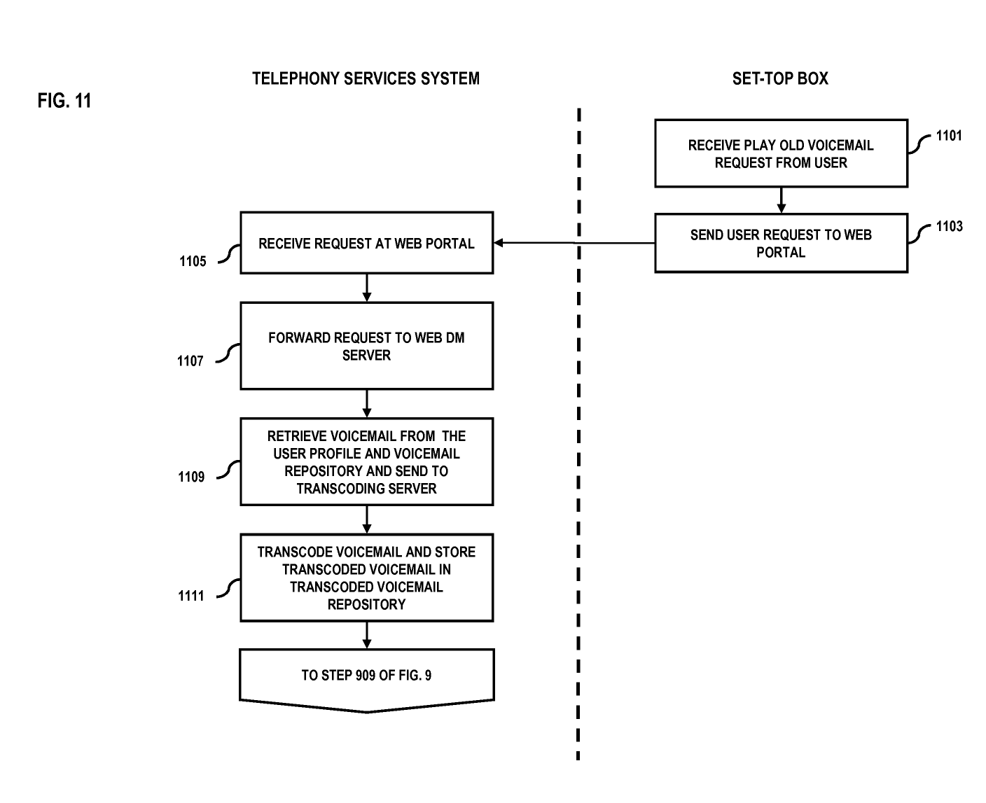

In step 1003, the voicemail server 217 sends the voicemail to the application server 207 according to an HTTP protocol. The application server 207 stores, per step 1005, the voicemail in the user profile and voicemail repository 209, where it may be retrieved for later playback (if it becomes an “old” voicemail) in the manner described with reference to FIG. 11. The application server 207 also sends the voicemail to the transcoding server 213, which, in step 1007, transcodes the voicemail and stores it in the transcoded voicemail repository 215, where it may be retrieved in the manner previously describe with reference to FIG. 9.

FIG. 11 is a flowchart of a process for providing old voicemails to an end user through a set-top box, according to an exemplary embodiment. In step 1101, the STB 103a receives a user request to play an old voicemail, i.e., a voicemail that has already been played. In step 1103, the request is sent to the web portal 201, which receives the request in step 1105.

In step 1107, the request is forwarded to the web server 205, through firewall 203. In step 1109, the web server 205 retrieves the voicemail from the user profile and voicemail repository 209, and sends it to the transcoding server 213. In step 1111, the transcoding server 213 transcodes the voicemail and stores the transcoded voicemail in the transcoded voicemail repository 215. The voicemail is then provided to the STB 103a according to steps 909-913 of FIG. 9.

FIG. 12 shows a main menu of a graphical user interface (GUI) for receiving user selections of call services, according to an exemplary embodiment. In this example, it is assumed that GUI 1200 is provided to a user associated with the STB 103a via, for instance, the display 407 (FIG. 4). In alternative embodiments, the GUI 1200 may be displayed on other display screens operatively coupled to the STB 103a. For example, the GUI 1204 may be displayed on the terminal 104 (FIG. 1A), on mobile device 109, or any other device capable of displaying a GUI and coupling to STB 103a.

The GUI 1200 is provided to the display 407 by the video processing circuitry 419 (FIG. 4) controlled by the controller 417 and the call services module 425. A user may manipulate the keypad 409 to highlight and select icons displayed on the GUI 1200 and otherwise interact with the GUI 1200.

Referring to FIG. 12, the GUI 1200 comprises a content panel 1202 and a menu panel 1206. The menu panel 1206 comprises a plurality of “tabs” (or interactive interface elements) 1208, 1210, 1212, 1214 and 1216, corresponding to various telephony services, including “SETTINGS” tab 1208, “CALL HISTORY” tab 1210, “VOICE MAIL” tab 1212, “CALLING FEATURES” tab 1214, and “VIDEO SERVICES” tab 1216. The content panel 1202 may display television programming, advertisements or the like.

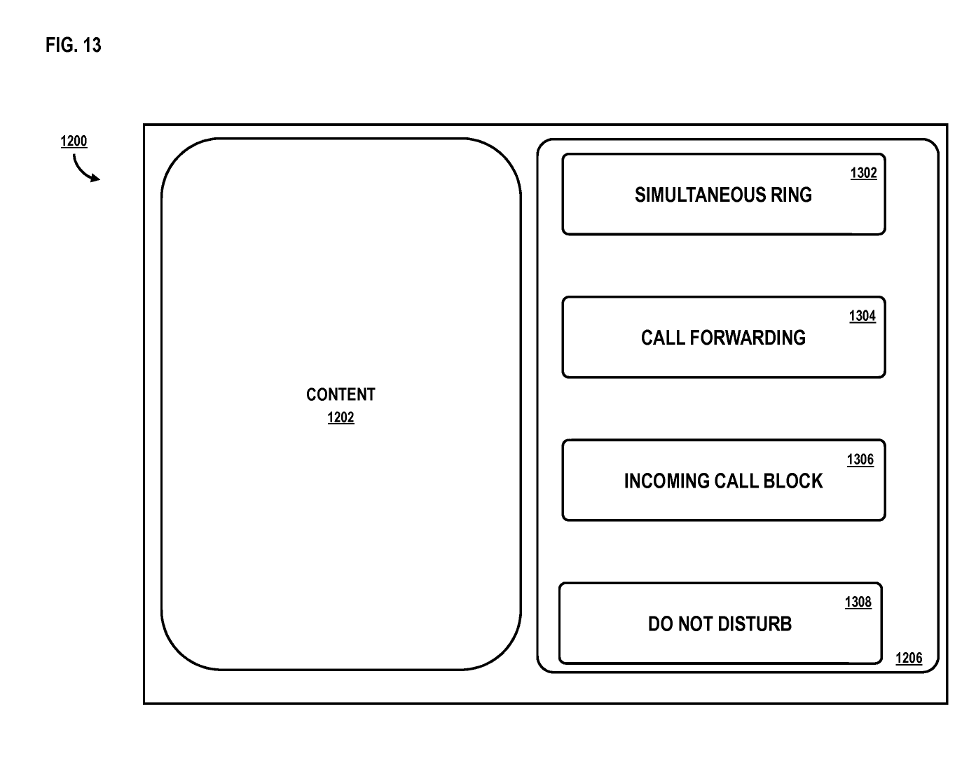

Selection of tab 1208 allows a user to view and alter various settings associated with telephony services. For example, as will be further described with reference to FIG. 13, the user may be able to select phone numbers to be associated with the STB 103a. Many other settings pertaining to the receipt and initiation of voice calls are contemplated.

Selection of tabs 1210 and 1212 result in the display of call history and voicemail logs, respectively. An exemplary GUI screen for the display of these logs will be described with reference to FIG. 16.

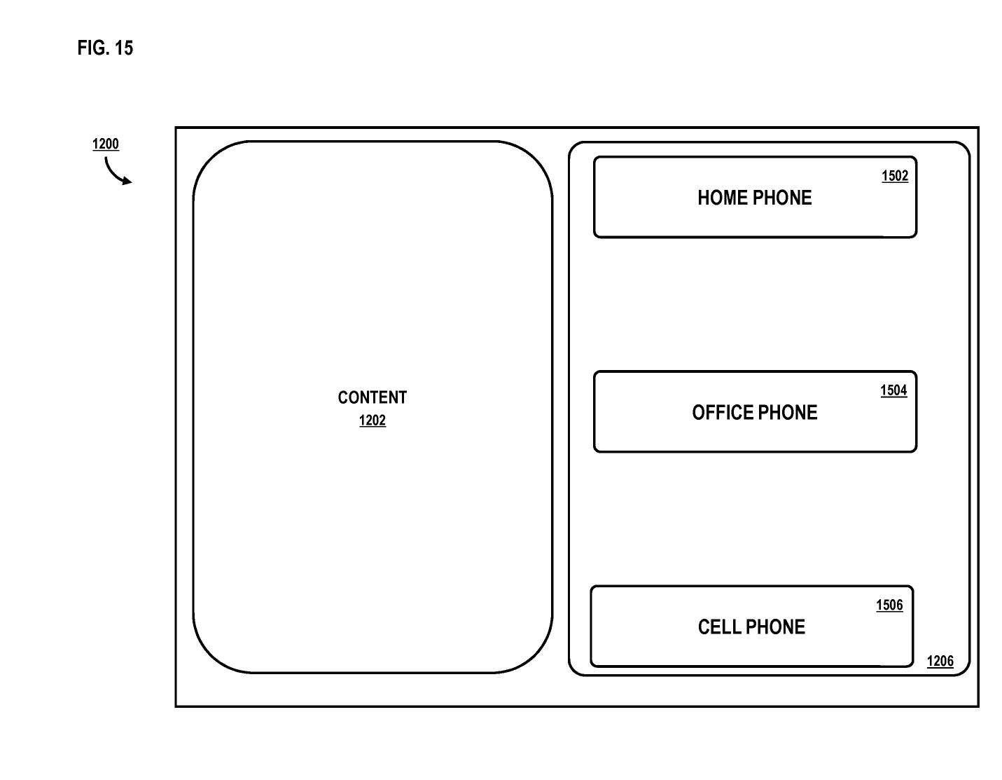

Selection of tab 1214 results in the display of a GUI screen that allows the user to select various call service features, such as call forwarding and the like, as will be further described with reference to FIG. 15.

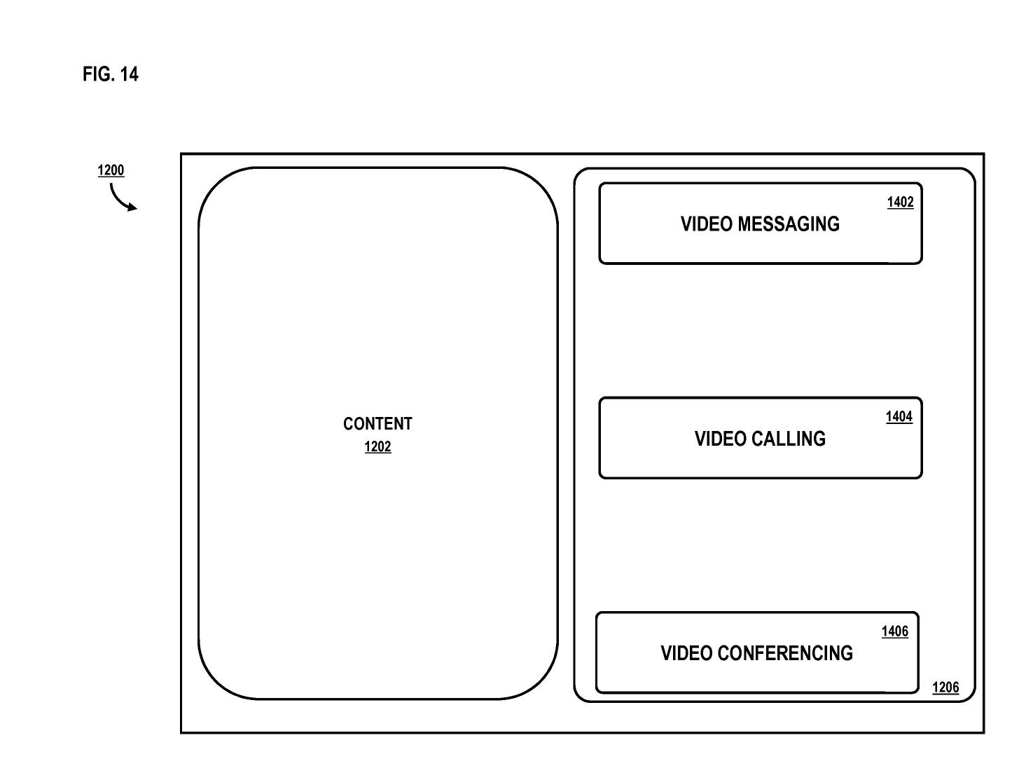

Selection of tab 1216 results in the display of a GUI screen that allows the user to select various video call services, as will be further described with reference to FIG. 14.

In other embodiments, menu panel 1206 may include one or more navigation trees, expandable table of contents, or, for example, FlashMedia presentations of selectable state identifiers, as well as other equivalent listings, menus, options, etc., for enabling a user to select various call services features.

In alternative embodiments, one or more navigational elements/fields may be provided and configured to indicate the existence of additional information, entries, fields, buttons, menus, etc., not displayed, but navigably available, as well as facilitate interface usability. Accordingly, the user may browse to additional information, entries, fields, etc., via, for instance, an input interface of a suitable device, e.g., keypad 409 in FIG. 4. One or more fixed focus states and/or distinctive magnification features, e.g., color, brightness, bolding, font type, text size, etc., may be used to convey information to the user.

FIG. 13 shows a GUI sub-menu for receiving user selections of various telephony services features, according to an exemplary embodiment. In this case, the menu panel 1206 comprises a plurality of tabs 1302, 1304, 1306 and 1308, corresponding to various call service features, including “SIMULTANEOUS RING” tab 1302, “CALL FORWARDING” tab 1304, “INCOMING CALL BLOCK” tab 1306 and “DO NOT DISTURB” tab 1308.

Selection of the “SIMULTANEOUS RING” tab 1302 results in the display of a sub-menu, described further with reference to FIG. 15, that enables a user to select a telephony device (or devices) that, when called, will result in a simultaneous notification of the call to be provided to the audio/video equipment and user interface 112 (FIG. 4) via STB 103a.

Selection of the “CALL FORWARDING” tab 1304 enables a user to configure various call forwarding settings, e.g. the telephone numbers associated with the telephony devices whose calls are to be forwarded, the telephone numbers associated with the telephony devices that are to receive the forwarded calls, the number of unanswered rings before a call is forwarded, and time/date selection when call forwarding is to occur.

Selection of the “INCOMING CALL BLOCK” tab 1306 enables a user to configure various call blocking settings, e.g. the telephone numbers that are to be blocked and time/date selection when such blocking is to occur.

Selection of the “DO NOT DISTURB” tab 1308 enables a user to configure various settings that govern the rejection of outside messages and/or calls directed to various telephony devices and/or the audio/video equipment and user interface 112 (FIG. 4).

FIG. 14 shows a GUI sub-menu for receiving user selections of video related call services, according to an exemplary embodiment. In this case, the menu panel 1206 comprises multiple tabs 1402, 1404, and 1406, corresponding to various video related telephony services, including “VIDEO MESSAGING” tab 1402, “VIDEO CALLING” tab 1404, and “VIDEO CONFERENCING” tab 1406. Selection of the tabs 1402, 1404 or 1406 result in the invocation of video messaging, video calling and video conferencing services, respectively.

FIG. 15 shows a GUI sub-menu for a calling feature that provides simultaneous notification of an incoming telephony at the set-top box and another device associated with a user of the user account, according to an exemplary embodiment. As previously mentioned, the screen shown in FIG. 15 is displayed in response to a user's selection of the “SIMULTANEOUS RING” tab 1302 shown in FIG. 13. As shown in FIG. 15, the menu panel 1206 includes tabs 1502, 1504, and 1506, corresponding to various telephony devices, including “HOME PHONE” tab 1502, “OFFICE PHONE” tab 1504, and “CELL PHONE” tab 1506. Selection of the tabs 1502, 1504 or 1506 result in simultaneous notification of an incoming phone call at the STB 103 and a home phone, office phone or cell phone, respectively.

FIG. 16 shows a GUI display of voicemail logs and/or call logs with user selectable entries, according to an exemplary embodiment. The menu panel 1206, in this example, displays a multitude of tabs 1602, 1604, 1606, 1608 and 1610, which correspond to respective log entries. Although FIG. 16 shows 5 log entries, the menu panel 1206 may display a variable number of log entries. According to an exemplary embodiment, the number of log entries to display may be programmable by the user by, e.g., interaction with the “SETTINGS” tab 1208 shown in FIG. 12.

In the case when a voicemail log is displayed, each of the entries 1602-1610 shows a variety of log data, which include, without limitation, the time and date of the voicemail, the telephone number of the device through which the voicemail was left, whether the voice mail is new or old, the telephone number and/or telephony device type (e.g., land line, cell phone) of the target telephony device, the duration of the message, the priority of the message, or any combination thereof. The user may highlight one of the log entries 1602-1608 by interacting with, e.g., the keypad 409 (FIG. 4), and then select the voicemail associated with the highlighted log entry for playback, thereby invoking the voicemail processes described with reference to FIG. 9 or 11. Other log entry selection mechanisms are contemplated.

In the case when a call log is displayed, each of the entries 1602-1610 shows a variety of log data, which include, without limitation, the time and date of the call, the telephone number of the device through which the call was made, whether the caller left a voice mail, the telephone number and/or telephony device type (e.g. land line, cell phone) of the target telephony device, and whether the user has already responded to the call via the STB 103b. The user may highlight or otherwise activate one of the log entries 1602-1608 by interacting with, e.g., the keypad 409 (FIG. 4), and then select the telephone number associated with the highlighted log entry for callback, thereby invoking the voicemail processes described with reference to FIG. 8. Other log entry selection mechanisms are contemplated.

The processes described herein for providing telephony services via a set-top box may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 17 illustrates computing hardware (e.g., computer system) upon which an embodiment according to the invention can be implemented. The computer system 1700 includes a bus 1701 or other communication mechanism for communicating information and a processor 1703 coupled to the bus 1701 for processing information. The computer system 1700 also includes main memory 1705, such as random access memory (RAM) or other dynamic storage device, coupled to the bus 1701 for storing information and instructions to be executed by the processor 1703. Main memory 1705 also can be used for storing temporary variables or other intermediate information during execution of instructions by the processor 1703. The computer system 1700 may further include a read only memory (ROM) 1707 or other static storage device coupled to the bus 1701 for storing static information and instructions for the processor 1703. A storage device 1709, such as a magnetic disk or optical disk, is coupled to the bus 1701 for persistently storing information and instructions.

The computer system 1700 may be coupled via the bus 1701 to a display 1711, such as a cathode ray tube (CRT), liquid crystal display, active matrix display, or plasma display, for displaying information to a computer user. An input device 1713, such as a keyboard including alphanumeric and other keys, is coupled to the bus 1701 for communicating information and command selections to the processor 1703. Another type of user input device is a cursor control 1715, such as a mouse, a trackball, or cursor direction keys, for communicating direction information and command selections to the processor 1703 and for controlling cursor movement on the display 1711.

According to an embodiment of the invention, the processes described herein are performed by the computer system 1700, in response to the processor 1703 executing an arrangement of instructions contained in main memory 1705. Such instructions can be read into main memory 1705 from another computer-readable medium, such as the storage device 1709. Execution of the arrangement of instructions contained in main memory 1705 causes the processor 1703 to perform the process steps described herein. One or more processors in a multi-processing arrangement may also be employed to execute the instructions contained in main memory 1705. In alternative embodiments, hard-wired circuitry may be used in place of or in combination with software instructions to implement the embodiment of the invention. Thus, embodiments of the invention are not limited to any specific combination of hardware circuitry and software.

The computer system 1700 also includes a communication interface 1717 coupled to bus 1701. The communication interface 1717 provides a two-way data communication coupling to a network link 1719 connected to a local network 1721. For example, the communication interface 1717 may be a digital subscriber line (DSL) card or modem, an integrated services digital network (ISDN) card, a cable modem, a telephone modem, or any other communication interface to provide a data communication connection to a corresponding type of communication line. As another example, communication interface 1717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1717 sends and receives electrical, electromagnetic, or optical signals that carry digital data streams representing various types of information. Further, the communication interface 1717 can include peripheral interface devices, such as a Universal Serial Bus (USB) interface, a PCMCIA (Personal Computer Memory Card International Association) interface, etc. Although a single communication interface 1717 is depicted in FIG. 17, multiple communication interfaces can also be employed.

The network link 1719 typically provides data communication through one or more networks to other data devices. For example, the network link 1719 may provide a connection through local network 1721 to a host computer 1723, which has connectivity to a network 1725 (e.g. a wide area network (WAN) or the global packet data communication network now commonly referred to as the “Internet”) or to data equipment operated by a service provider. The local network 1721 and the network 1725 both use electrical, electromagnetic, or optical signals to convey information and instructions. The signals through the various networks and the signals on the network link 1719 and through the communication interface 1717, which communicate digital data with the computer system 1700, are exemplary forms of carrier waves bearing the information and instructions.

The computer system 1700 can send messages and receive data, including program code, through the network(s), the network link 1719, and the communication interface 1717. In the Internet example, a server (not shown) might transmit requested code belonging to an application program for implementing an embodiment of the invention through the network 1725, the local network 1721 and the communication interface 1717. The processor 1703 may execute the transmitted code while being received and/or store the code in the storage device 1709, or other non-volatile storage for later execution. In this manner, the computer system 1700 may obtain application code in the form of a carrier wave.

The term “computer-readable medium” as used herein refers to any medium that participates in providing instructions to the processor 1703 for execution. Such a medium may take many forms, including but not limited to non-volatile media, volatile media, and transmission media. Non-volatile media include, for example, optical or magnetic disks, such as the storage device 1709. Volatile media include dynamic memory, such as main memory 1705. Transmission media include coaxial cables, copper wire and fiber optics, including the wires that comprise the bus 1701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

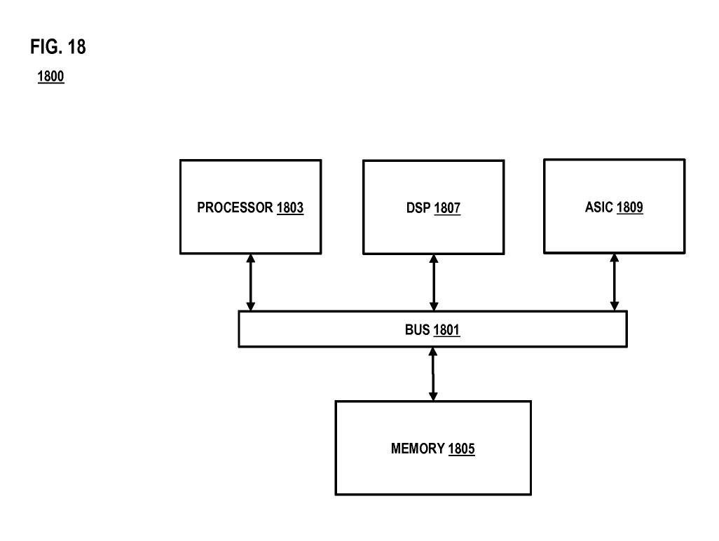

FIG. 18 illustrates a chip set 1800 upon which an embodiment of the invention may be implemented. Chip set 1800 is programmed to present a slideshow as described herein and includes, for instance, the processor and memory components described with respect to FIG. 18 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1800, or a portion thereof, constitutes a means for performing one or more steps of FIGS. 1B, 1C, 5A, 5B, and 6-11.

In one embodiment, the chip set 1800 includes a communication mechanism such as a bus 1801 for passing information among the components of the chip set 1800. A processor 1803 has connectivity to the bus 1801 to execute instructions and process information stored in, for example, a memory 1805. The processor 1803 may include one or more processing cores with each core configured to perform independently. A multi-core processor enables multiprocessing within a single physical package. Examples of a multi-core processor include two, four, eight, or greater numbers of processing cores. Alternatively or in addition, the processor 1803 may include one or more microprocessors configured in tandem via the bus 1801 to enable independent execution of instructions, pipelining, and multithreading. The processor 1803 may also be accompanied with one or more specialized components to perform certain processing functions and tasks such as one or more digital signal processors (DSP) 1807, or one or more application-specific integrated circuits (ASIC) 1809. A DSP 1807 typically is configured to process real-world signals (e.g., sound) in real time independently of the processor 1803. Similarly, an ASIC 1809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1803 and accompanying components have connectivity to the memory 1805 via the bus 1801. The memory 1805 includes both dynamic memory (e.g., RAM, magnetic disk, writable optical disk, etc.) and static memory (e.g., ROM, CD-ROM, etc.) for storing executable instructions that when executed perform the inventive steps described herein to providing telephony services via a set-top box. The memory 1805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
executing an authentication procedure to authenticate a set-top box associated with a user account; and
receiving at the set-top box, a data stream representing a voicemail associated with the user account, wherein the data stream is selectively transcoded in real-time for delivery to the set-top box.

2. A method according to claim 1, further comprising:
presenting, via the set-top box, an option to view an item corresponding to the voicemail, wherein selection of the item invokes downloading of the data stream.

3. A method according to claim 2, further comprising:
presenting, via the set-top box, a video program concurrently with the option.

4. A method according to claim 1, further comprising:
retrieving call detail information corresponding to the voicemail; and
presenting, via the set-top box, the call detail information.

5. A method according to claim 4, wherein the call detail information includes information for a plurality of telephony services associated with the user account.

6. A method according to claim 1, further comprising:
presenting, via the set-top box, a calling processing menu including one or more call processing features relating to a call associated with the user account.

7. An apparatus comprising:
at least one processor; and
at least one memory including computer program code for one or more programs,
the at least one memory and the computer program code configured to, with the at least one processor, cause the apparatus to perform at least the following,
execute an authentication procedure to authenticate a set-top box associated with a user account; and
receive at the set-top box, a data stream representing a voicemail associated with the user account, wherein the data stream is selectively transcoded in real-time for delivery to the set-top box.

8. An apparatus according to claim 7, wherein the apparatus is further caused to:
present, via the set-top box, an option to view an item corresponding to the voicemail, wherein selection of the item invokes downloading of the data stream.

9. An apparatus according to claim 8, wherein the apparatus is further caused to:
present, via the set-top box, a video program concurrently with the option.

10. An apparatus according to claim 7, wherein the apparatus is further caused to:
retrieve call detail information corresponding to the voicemail; and
present, via the set-top box, the call detail information.

11. An apparatus according to claim 10, wherein the call detail information includes information for a plurality of telephony services associated with the user account.

12. An apparatus according to claim 7 wherein the apparatus is further caused to:
present, via the set-top box, a calling processing menu including one or more call processing features relating to a call associated with the user account.

13. A system comprising:
a voicemail platform configured to store a plurality of voicemails associated with a respective plurality of subscribers, wherein the subscribers are associated with a respective plurality of set-top boxes; and
a transcoder configured to transcode one of the voicemails for streaming of the one voicemail to a corresponding one of the set-top boxes associated with subscriber.

14. A system according to claim 13, further comprising:
an application server configured to receive a command from a web portal relating to the streaming of the voicemails to the respective set-top boxes.

15. A system according to claim 13, wherein the one set-top box is configured to present an option to view an item corresponding to the voicemail, and selection of the item invokes downloading of the data stream.

16. A system according to claim 15, wherein the one set-top box is configured to present a video program concurrently with the option.

17. A system according to claim 13, wherein the one set-top box is configured to retrieve call detail information corresponding to the voicemail, and to present the call detail information.

18. A system according to claim 17, wherein the call detail information includes information for a plurality of telephony services associated with the user account.

19. A system according to claim 13, wherein the one set-top box is configured to present a calling processing menu including one or more call processing features relating to a call associated with the user account.

20. A system according to claim 13, wherein the one set-top box is authenticated prior to initiation of the streaming of the voice mail.
